(19) United States
(12) Patent Application Publication
(10) Pub. No.: US 2010/0223064 A1
(43) Pub. Date: Sep. 2, 2010

(54) SYSTEM AND METHOD FOR PROVIDING A PERSONALIZED REFERENCE COLLECTION

(75) Inventor: Geoffry A. Westphal, Evanston, IL (US)

Correspondence Address: GREENBERG TRAURIG, LLP, 77 WEST WACKER DRIVE, SUITE 3100, CHICAGO, IL, 60601-1732, US

(73) Assignee: W.W. Grainger, Inc., Lake Forest, IL (US)

(21) Appl. No.: 12/394,458

(22) Filed: Feb. 27, 2009

(51) Int. Cl. G06Q 99/00

(52) U.S. Cl. 705/1.1; 705/14.66

(57) ABSTRACT

A system and method for providing a reference collection that is personalized for a consumer. The system includes a server computer having an associated data repository. Stored in the data repository is an aggregation of links to sources of on-line information and each link within the aggregation is mapped to one or more consumer communities and/or products. Programming resident on the server computer acts to provide to a client computer a webpage that includes a reference collection that is personalized for the consumer, the reference collection being provided as a listing of those links within the aggregation of links to sources of on-line information that have been mapped within the data repository to a one or more consumer communities to which the consumer belongs and/or products of interest to the consumer.

### BACKGROUND

There are numerous websites that allow consumers to purchase products online. In the art, it is known to provide consumers visiting such websites with personalized product recommendations. By way of example, U.S. Pat. No. 6,317,722 discloses a system and method for providing personalized product recommendations to consumers which functions by using the collective interests of a community of consumers. To this end, a similar product table is created, using an off-line process, that functions to map a known product to a set of products that are identified as being similar to the known product. Similarity is measured by a weighted score value that is indicative of the number of consumers that have an interest in two products relative to the number of consumers that have an interest in either product. The numbers utilized to establish similarity in this manner are typically derived by examining invoices to determine when the two products appear together and when one product appears exclusive of the other product. The weighting value may be indicative of consumer ratings provided to products and/or a time duration since a product pair was last purchased.

By way of still further example, U.S. Pat. No. 6,064,980 discloses a system and method for providing personalized product recommendations to consumers which functions by correlating product ratings provided by a consumer with product ratings provided by other consumers within a purchasing community. Yet further, commonly assigned, US Publication No. 2006/0036510 discloses a system and method for personalized providing product recommendations to consumers that functions by using relationships between various product attributes, such as different brand names of products often purchased together by consumers, different categories of products often purchased together by consumers, etc.

These publications, which exemplify the current state of the art, are incorporated herein by reference in their entirety.

### SUMMARY

The following generally describes a system and method for providing consumers with personalized reference collections. The personalized reference collections are provided to consumers in connection with websites that allow consumers to purchase products or service online or offline (collectively referred to hereinafter as “products”). The personalized reference collections are preferably provided to consumers in a page presented in a device display (hereinafter generally referred to as a “webpage”) and the webpage may additionally provide to consumers one or more otherwise conventional website features and functions, such as personalized product recommendations, a shopping cart, product search capabilities, etc.

More particularly, the following describes a system for providing a reference collection that is personalized for a consumer wherein the system includes a server computer having an associated data repository. Stored in the data repository is an aggregation of links to sources of on-line information and each link within the aggregation is mapped to one or more consumer communities and/or products. Programming resident on the server computer acts to provide to a client computer a webpage that includes a reference collection that is personalized for the consumer, the reference collection being provided as a listing of those links within the aggregation of links to sources of on-line information that have been mapped within the data repository to a one or more consumer communities to which the consumer belongs and/or products of interest to the consumer.

A better understanding of the objects, advantages, features, properties and relationships of the system and method for providing consumers with personalized reference collections will be obtained from the following detailed description and accompanying drawing that set forth illustrative embodiments that are indicative of the various ways in which the principles expressed hereinafter may be employed.

### BRIEF DESCRIPTION OF THE DRAWINGS

For a better understanding of the system and method for providing consumers with personalized reference collections reference may be had to preferred embodiments shown in the following drawings in which:

FIG. 1 is a block diagram illustrating an exemplary computer system in which the principles of the described invention may be employed;

FIG. 2 is a flow chart diagram illustrating exemplary steps for establishing and presenting to a consumer a personalized reference collections; and

FIG. 3 illustrates an exemplary web page with an exemplary personalized reference collection.

### DETAILED DESCRIPTION

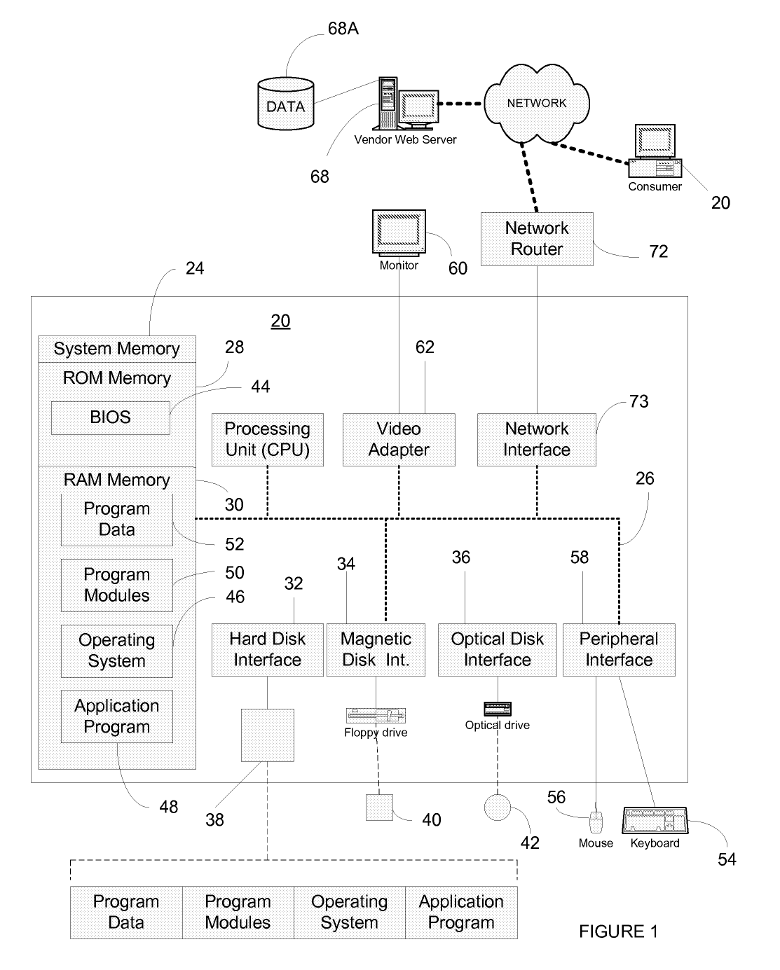

With reference to the figures, a system and method for providing consumers with personalized reference collections is hereinafter described. In particular, as illustrated in FIG. 1, the system and method will be described in the context of a plurality of processing devices linked via a network, such as the World Wide Web or the Internet. In this regard, a processing device 20, illustrated in the exemplary form of a computer system, is provided with executable instructions to, for example, provide a means for a consumer to access a vendor server 68 and thereby view vendor website pages. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

An end-user, e.g., a consumer, may enter commands and information into the processing device 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the vendor server 68 having associated data repository 68A. In this regard, while the remote processing device 68 has been illustrated in the exemplary form of a computer, it will be appreciated that the remote processing device 68 may, like processing device 20, be any type of device having processing capabilities. Again, it will be appreciated that the remote processing device 68 need not be implemented as a single device but may be implemented in a manner such that the tasks performed by the remote processing device 68 are distributed to a plurality of processing devices linked through a communication network.

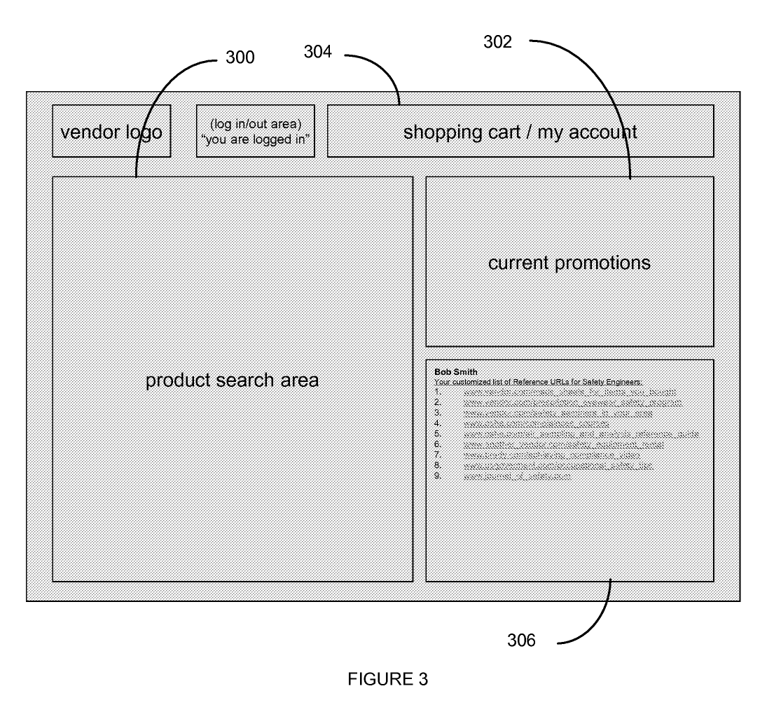

For performing tasks as needed, the remote processing device 68 may include many or all of the elements described above relative to the processing device 20. By way of further example, the remote processing device 68 may include the executable instructions for handling search requests, providing search results, providing dynamically constructed webpages (such as illustrated in FIG. 3), etc. Communications between the processing device 20 and the remote processing device 68 may be exchanged via a further processing device, such a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the remote processing device 68.

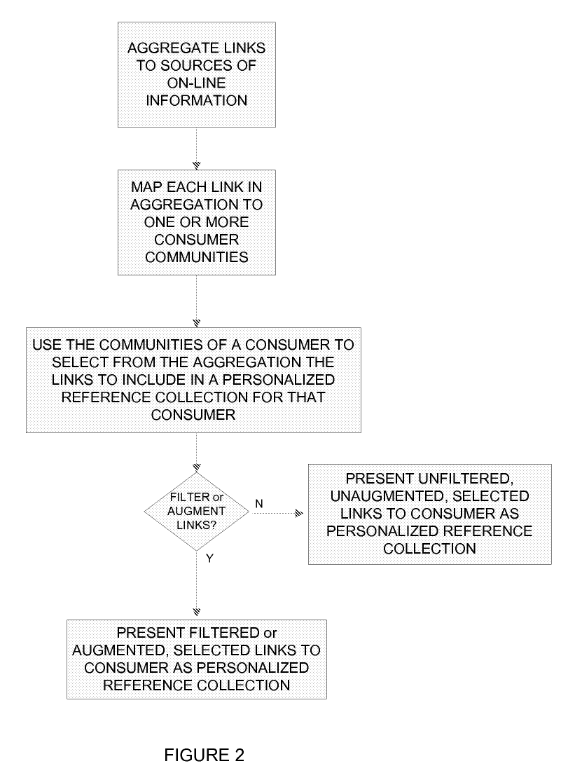

To provide consumers with personalized reference collections, the data repository 68A preferably includes a data structure in which is maintained links to sources of on-line information. The sources of on-line information may include, but need not be limited to, web chat rooms, webpages showing parts diagrams, industry blogs, websites having local and/or federal government regulations, trade association websites, job placement websites, news websites, magazine websites, manufacturer websites, websites having product safety information, websites having financial information, etc. Within the data repository 68A, the links to these various sources of on-line information are preferably cross-referenced or mapped to various different categories or communities to which consumers may belong or be placed and/or to various different products that are offered for sale by the vendor. In this regard, a consumer may be placed into a particular community of users either explicitly (for example by a consumer selecting from a list of predefined communities that are presented to the consumer by the vendor) or implicitly (for example by the vendor using prior purchasing histories of a consumer and others to discern one or more communities into which to place a consumer). Thus, as illustrated in FIG. 2, the vendor can aggregate links to various different sources of on-line information and create in the data repository 68A a mapping between various of the collected links and plural different consumer communities and then use the one or more communities to which a given consumer belongs to thereby provide or present to that consumer a personalized reference collection, e.g., a listing of links to the sources of on-line information that have been mapped to the community or communities to which that consumer belongs.

By way of example, FIG. 3 illustrates an exemplary webpage which provides to a consumer conventional website features and functionality, such as a product search area 300, product promotions or recommendations 302, shopping cart access 304, etc., as well as a personalized reference collection 306. In the example illustrated, the customer “Bob Smith” is known to be a member of the “Safety Engineers” community and, as such, the personalized reference collection 306 for “Bob Smith” is populated with those links to on-line information sources within the aggregation of links to on-line information sources that have been mapped to the “Safety Engineers” community within the data repository 68A. Further, realizing that not all customers within a given community may buy exactly the same products, share the same interests, or otherwise require access to the same information, the system, as additionally illustrated in FIG. 2, may function to filter (or augment) the links to information sources that are initially selected from the data repository 68A for presentation to a consumer considering the previous purchasing history of that consumer, products within that consumer's shopping cart, links that consumer has specifically requested by removed or added to the collection, etc. Thus, for example, if the system determines that a consumer has an interest in Freon®, based from their past purchasing history, their shopping cart, an explicit request, etc., the system may provide the personalized reference collection for that consumer with resource links related to Freon®, e.g., handling instructions, material safety sheets, etc., whereas another customer in the same community which the system determines does not have an interest in Freon® will not necessarily be provided with the same links.

While specific embodiments of the invention have been described in detail, it will be appreciated by those skilled in the art that various modifications and alternatives to those details could be developed in light of the overall teachings of the disclosure. For example, while described in the context of using communities of consumers to provide personalized reference collections, it will be understood that the aggregation of links to sources of on-line information may be mapped to one or more products being sold by the vendor of products whereby the personalized reference collection may include those links within the aggregation of links to sources of on-line information that have been mapped within the data repository to one or more products appearing in a prior purchasing history, shopping cart, etc. of a consumer. Accordingly, the particular arrangement disclosed is meant to be illustrative only and not limiting as to the scope of the invention which is to be given the full breadth of the appended claims and any equivalents thereof.

What is claimed is:

1. A system for providing a reference collection that is personalized for a consumer, comprising:
a server computer operated by a vendor of products having an associated data repository in which is stored an aggregation of links to sources of on-line information wherein each link within the aggregation is mapped to one or more consumer communities; and
programming resident on the server computer which acts to provide to a client computer a webpage that includes the reference collection that is personalized for the consumer wherein the reference collection comprises a listing of those links within the aggregation of links to sources of on-line information that have been mapped within the data repository to a one or more consumer communities to which the consumer belongs.

2. The system as recited in claim 1, wherein the programming filters the listing of those links within the aggregation of links to sources of on-line information that have been mapped within the data repository to the one or more consumer communities to which the consumer belongs.

3. The system as recited in claim 1, wherein the programming filters the listing of those links within the aggregation of links to sources of on-line information that have been mapped within the data repository to the one or more consumer communities to which the consumer belongs as a function of a prior purchasing history of the consumer with the vendor of products.

4. The system as recited in claim 1, wherein the programming filters the listing of those links within the aggregation of links to sources of on-line information that have been mapped within the data repository to the one or more consumer communities to which the consumer belongs as a function of one or more products of the vendor of products that have been placed within an on-line shopping cart by the consumer.

5. The system as recited in claim 1, wherein the programming augments the listing of those links within the aggregation of links to sources of on-line information that have been mapped within the data repository to the one or more consumer communities to which the consumer belongs with additional links selected from the aggregation of links to sources of on-line information.

6. The system as recited in claim 1, wherein the programming augments the listing of those links within the aggregation of links to sources of on-line information that have been mapped within the data repository to the one or more consumer communities to which the consumer belongs with additional links selected from the aggregation of links to sources of on-line information as a function of a prior purchasing history of the consumer with the vendor of products.

7. The system as recited in claim 1, wherein the programming augments the listing of those links within the aggregation of links to sources of on-line information that have been mapped within the data repository to the one or more consumer communities to which the consumer belongs with additional links selected from the aggregation of links to sources of on-line information as a function of one or more products of the vendor of products that have been placed within an on-line shopping cart by the consumer.

8. A system for providing a reference collection that is personalized for a consumer, comprising:
a server computer operated by a vendor of products having an associated data repository in which is stored an aggregation of links to sources of on-line information wherein each link within the aggregation is mapped to one or more products being sold by the vendor of products; and
programming resident on the server computer which acts to provide to a client computer a webpage that includes the reference collection that is personalized for the consumer wherein the reference collection comprises a listing of those links within the aggregation of links to sources of on-line information that have been mapped within the data repository to one or more products appearing in a prior purchasing history of the consumer.

9. The system as recited in claim 8, wherein the programming filters the listing of those links within the aggregation of links to sources of on-line information that have been mapped within the data repository to the one or more products appearing in the prior purchasing history of the consumer.

10. The system as recited in claim 8, wherein the programming augments the listing of those links within the aggregation of links to sources of on-line information that have been mapped within the data repository to the one or more products appearing in the prior purchasing history of the consumer with additional links selected from the aggregation of links to sources of on-line information.

11. A system for providing a reference collection that is personalized for a consumer, comprising:
a server computer operated by a vendor of products having an associated data repository in which is stored an aggregation of links to sources of on-line information wherein each link within the aggregation is mapped to one or more products being sold by the vendor of products; and
programming resident on the server computer which acts to provide to a client computer a webpage that includes the reference collection that is personalized for the consumer wherein the reference collection comprises a listing of those links within the aggregation of links to sources of on-line information that have been mapped within the data repository to one or more products appearing in an on-line shopping cart of the consumer.

12. The system as recited in claim 11, wherein the programming filters the listing of those links within the aggregation of links to sources of on-line information that have been mapped within the data repository to the one or more products appearing in the on-line shopping cart of the consumer.

13. The system as recited in claim 11, wherein the programming augments the listing of those links within the aggregation of links to sources of on-line information that have been mapped within the data repository to the one or more products appearing in the on-line shopping cart of the consumer with additional links selected from the aggregation of links to sources of on-line information.
